(19) United States
(12) Patent Application Publication
(10) Pub. No.: US 2025/0354943 A1
(43) Pub. Date: Nov. 20, 2025

(54) Analysis of Low-energy X-ray Fluorescence Emitted from Sample in Atmospheric Environment

(71) Applicant: BRUKER TECHNOLOGIES LTD., Migdal HaEmek (IL)

(72) Inventors: Asher Peled, Haifa (IL); Alexander Krokhmal, Haifa (IL); Matthew Wormington, Littleton, CO (US)

(21) Appl. No.: 19/178,955

(22) Filed: Apr. 15, 2025

Related U.S. Application Data
(60) Provisional application No. 63/649,378, filed on May 19, 2024.

(51) Int. Cl. G01N 23/223

(52) U.S. Cl. CPC G01N 23/223; G01N 2223/204; G01N 2223/317; G01N 2223/3307

(57) ABSTRACT

A system for X-ray analysis, the system includes: (a) an X-ray analysis assembly, which is (i) disposed in an X-ray enclosure configured to maintain a controlled first pressure, and (ii) configured to direct a first X-ray beam toward a sample positioned out of the X-ray enclosure at a second pressure different from the first pressure, and to produce a signal indicative of a second X-ray beam emitted from the sample in response to the first X-ray beam impinging on the sample, and (b) a window assembly, which is disposed between the X-ray analysis assembly and the sample and is configured to (i) seal the X-ray enclosure to maintain a pressure difference between the first and second pressures, and (ii) pass the first and second X-ray beams, and the window assembly includes a window layer made from a material transparent to the first and second X-ray beams.

### CROSS-REFERENCE TO RELATED APPLICATIONS

This application claims the benefit of U.S. Provisional Patent Application 63/649,378, filed May 19, 2024, whose disclosure is incorporated herein by reference.

### FIELD OF THE INVENTION

The present invention relates generally to X-ray analysis, and particularly to methods and systems for analysis of low-energy X-ray fluorescence emitted from a sample positioned in atmospheric environment.

### BACKGROUND OF THE INVENTION

Various techniques have been developed for measuring X-ray fluorescence emitted from a sample positioned in atmospheric environment.

For example, Japanese Patent Application JP 2001-105636 A, describes an X-ray fluorescence analyzer including a measurement unit, a movable unit, and a measurement unit including a first opening, a measurement chamber, an X-ray source for irradiating primary X-rays toward the first opening, an X-ray detector for detecting secondary X-rays, a suction/exhaust means for sucking/exhausting the inside of the measurement chamber, and a gas introduction means a gas into the for introducing measurement chamber.

### SUMMARY OF THE INVENTION

An embodiment of the present invention that is described herein provides a system for X-ray analysis, the system includes: (a) an X-ray analysis assembly, which is (i) disposed in an X-ray enclosure configured to maintain a controlled first pressure, and (ii) configured to direct a first X-ray beam toward a sample positioned out of the X-ray enclosure at a second pressure different from the first pressure, and to produce a signal indicative of a second X-ray beam emitted from the sample in response to the first X-ray beam impinging on the sample, and (b) a window assembly, which is disposed between the X-ray analysis assembly and the sample and is configured to (i) seal the X-ray enclosure to maintain a pressure difference between the first and second pressures, and (ii) pass the first and second X-ray beams, and the window assembly includes a window layer made from a material transparent to the first and second X-ray beams.

In some embodiments, the window layer includes a compound of silicon-nitride. In other embodiments, the window layer includes a membrane of graphene or silicon carbide (Sic). In yet other embodiments, the X-ray analysis assembly includes one or more detectors configured to produce the signal in response to detecting the second X-ray beam, and the window layer is electrically conductive and is configured to prevent electrons and charged particles emitted from the sample from at least one of (i) adhering to a window surface of the window layer facing the sample, and (ii) entering the one or more detectors.

In some embodiments, the X-ray analysis assembly includes one or more detectors configured to produce the signal in response to detecting the second X-ray beam, and the system further includes a charge trap integrated within the X-ray enclosure and configured to prevent electrons and charged particles from entering the one or more detectors. In other embodiments, the sample is disposed on a stage configured to move the sample along at least an axis, and the system further includes a processor configured to control the stage to move the sample along the axis relative to the X-ray enclosure and to position a first surface of the sample at a distance less than 0.5 mm from the window surface of the window layer facing the first surface. In yet other embodiments, the second pressure includes an atmospheric pressure, and the processor is configured to control a flow of a helium gas or a nitrogen gas between the first and second surfaces.

In some embodiments, the window assembly includes the window layer made from the material, which is formed over an additional layer, and the additional layer (i) is less transparent to the first and second X-ray beams compared to the window layer, and (ii) has an opening for passing the first and second X-ray beams. In other embodiments, the opening is smaller than 5 mm, and the window layer has a thickness smaller than 0.5 μm.

In some embodiments, the X-ray analysis assembly has an X-ray source that includes: (i) an anode having an anode metal film configured to emit the first X-ray beam having a given energy, the anode metal film (a) has an electrical conductivity greater than 8.3×10⁴ S/m and (b) is formed over a base layer having a thermal conductivity greater than 300 W/(m-K) at 600° C., and (ii) one or more cathode emitters configured to produce an electron beam directed to the anode to produce the first X-ray beam, the second pressure includes an atmospheric pressure, and the second X-ray beam includes X-ray fluorescence (XRF) emitted from the sample at a depth less than 1000 nm.

There is additionally provided, in accordance with an embodiment of the present invention, a method for producing an X-ray analysis system, the method includes disposing, in an X-ray enclosure configured to maintain a controlled first pressure, an X-ray analysis assembly configured to direct a first X-ray beam toward a sample positioned out of the X-ray enclosure at a second pressure different from the first pressure, and to produce a signal indicative of a second X-ray beam emitted from the sample in response to the first X-ray beam impinging on the sample. A window assembly is coupled to the X-ray enclosure, the window assembly is configured to (i) seal the X-ray enclosure to maintain a pressure difference between the first and second pressures, and (ii) pass the first and second X-ray beams, and the window assembly includes a window layer made from a material transparent to the first and second X-ray beams.

The present invention will be more fully understood from the following detailed description of the embodiments thereof, taken together with the drawings in which:

### BRIEF DESCRIPTION OF THE DRAWINGS

FIG. 1 is a schematic, side view of an X-ray analysis system, in accordance with an embodiment of the present invention; and

FIG. 2 is a flow chart that schematically illustrates a method for producing the system of FIG. 1, in accordance with an embodiment of the present invention.

### DETAILED DESCRIPTION OF EMBODIMENTS

### Overview

Measurement and analysis of semiconductor devices using X-ray analysis systems, such as X-ray fluorescence (XRF) systems, typically requires tight control of the X-ray beam properties, such as but not limited to the energy of the X-ray beam. In some cases, the X-ray application requires positioning the sample in atmospheric environment, it is noted however that in atmospheric environment the intensity of the X-ray beam is typically reduced compared to that vacuum environment.

Embodiments of the present invention that are described herein provide methods and systems for enabling accurate and precise measurements of low-energy X-ray fluorescence lines while the sample is positioned in atmospheric environment.

In some embodiments, a system for X-ray analysis (also referred to herein as a system, for brevity) comprises an X-ray analysis assembly having at least: (i) an X-ray source configured to direct an X-ray beam to impinge on a surface of a sample (in present example, a semiconductor wafer having layers and structures formed thereon), and (ii) X-ray optics configured to control the properties and direction of the X-ray beam, and (iii) a detector sub-assembly configured to receive fluorescence radiation excited from the sample in response to the impinged X-ray beam. The system further comprises a chuck configured to hold the sample, and a stage configured to move the sample relative to the X-ray analysis assembly.

In some embodiments, static components of the XRF system (e.g., X-ray source, X-ray optics, and X-ray detectors) are positioned in an environment with low X-ray absorption, such as in vacuum or in a tank filled with helium. In an embodiment, in both cases (e.g., vacuum or helium), the (vacuum) chamber of the system has an opening, and comprises a stiff window, which is transparent to (low-energy) X-rays and is configured to seal the opening of the chamber, and thereby, to maintain the vacuum in the vacuum chamber (i.e., to maintain the pressure difference between the vacuum in the chamber and the atmospheric environment out of the chamber, as will be described below. In some embodiments, the window is typically made from a ceramic material, such as but not limited to (i) a compound of silicon-nitride, such as Si₃N₄ or any other suitable compound, or (ii) graphene, which is made from carbon (not a ceramic material) typically extracted from graphite, and is made up of pure carbon, or (iii) a compound of silicon and carbide (e.g., SiC). In the present example, the window has a thickness less than about 1 μm (e.g., equal to or less than about 0.5 μm), and the graphene has a shape of a membrane. In other embodiments, the window may comprise any other suitable, stiff material that is transparent to low-energy X-rays without significant degradation upon X-ray exposure and providing sufficient mechanical strength to withstand and sustain a pressure differential of approximately one (1) atmosphere between the two faces of the window. The window material is selected to be free of small amounts of contaminated elements such as chlorine that can introduce unwanted X-ray emissions and interference with the measurement of the elements of interest.

In some embodiments, the sample is placed in an atmospheric environment in close proximity to the window. In the present example, a distance (also referred to herein as an air gap) between (i) an outer surface of the window, and (ii) an outer surface of the sample facing the window, is between about 100 μm and 500 μm, or any other suitable distance less than about 1 mm. In this configuration, the X-ray path, excitation, and detection predominantly occur in the controlled vacuum environment, with only the small air gap between the sample and the X-ray windows as described above.

In some embodiments, the system comprises a chuck configured to hold the sample, and a stage configured to move the sample relative to the X-ray analysis assembly. The movement of stage is controlled to move laterally (e.g., in an XY plane) approximately parallel to the surface of the sample) and to maintain the aforementioned 100 μm-500 μm air gap while performing the XRF measurements and analysis. In some embodiments, the system comprises a proximity sensor configured to output a signal indicative of the air gap distance, so as to reduce the X-ray attenuation and the variability of the X-ray energy that may occur due to small fluctuations in the ambient conditions of the sample. In some embodiments and depending to the application requirements, the 100 μm-500 μm air gap can additionally be flooded with a continuous stream of gas, such as helium or nitrogen, causing less attenuation of the X-ray energy compared to that of air or other gases or removing X-ray lines that can interfere with the measurements, most notably Argon (Ar).

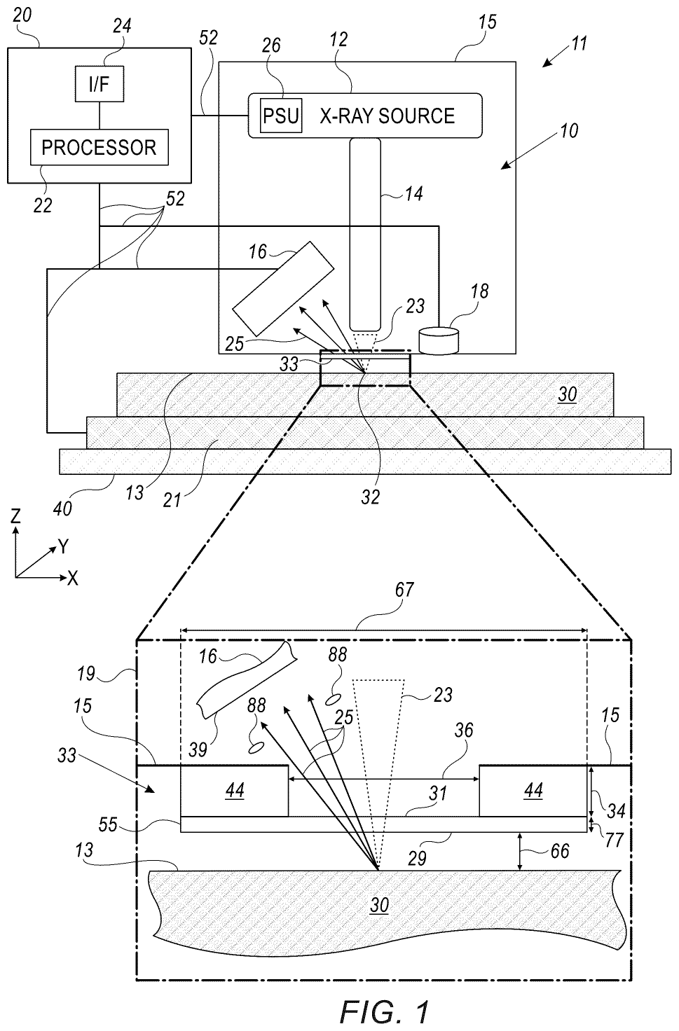

In some embodiments, the window is made from electrically conductive materials, such as the SiC and graphene described above, so as to reduce (and preferably prevent) electrons (and charged particles) emitted from the sample from entering the aforementioned detector(s) of the system. Additionally, or alternatively, the system comprises a magnetic-based charge trap integrated within the vacuum chamber, for example, between the sample and the detectors, and configured to prevent electrons and charged particles from entering the detector(s). The configuration of the window and charge trap are described in detail in FIG. 1 below.

### System Description

FIG. 1 is a schematic, side view of an X-ray analysis system 11, in accordance with an embodiment of the present invention.

In some embodiments, system 11 comprises an X-ray fluorescence (XRF) analysis system, but at least some of the embodiments described in the present disclosure are applicable, mutatis mutandis, to other sorts of X-ray analysis systems, and to other sorts of systems used for analyzing and/or processing semiconductor-based samples during very large-scale integration (VLSI) processes for producing integrated circuit (IC) devices.

In some embodiments, system 11 comprises (i) an X-ray source 12 configured to receive power from a power supply unit (PSU) 26 and to emit an X-ray beam 23 toward a sample 30. In the present example, sample 30 comprises a silicon wafer having layers and structures that are patterned using any suitable VLSI processes.

In some embodiments, X-ray source 12 may comprise a traditional wire-filament source of electrons or more advanced systems such as cold (dispenser) cathodes or LaB₆ (also referred to herein as Lab6 described below) emitters (not shown) supplied by (i) Incoatec GmbH, Max-Planck-Str. 2, 21502 Geesthacht, Germany, or (ii) Excillum AB, Jan Stenbecks Torg 17, 164 40 Kista, Sweden.

In some embodiments, the tubes with cold (dispenser) and lanthanum hexaboride (LaB6) cathode emitters are configured to emit low-energy X rays (that may be operated at lower voltage (e.g., about 35 kV) and higher current (e.g., about 1.8 mA) compared to that of traditional X-ray tubes, such as the aforementioned wire-filament source. The anode (not shown) of source 12 may comprise an elemental metal rhodium (Rh) or copper (Cu), or alloy having X-ray emission lines that are particularly suitable for exciting low-energy X-rays in sample 30 (e.g., Rh La emission of about 2.7 keV). The anode metal may be deposited as a film over a base layer having high thermal conductivity, such as thick copper, diamond, or silicon carbide (Sic). In the present example, the thermal conductivity of the base layer is greater than 300 W/(m-K) at a temperature of about 600° C.

In other embodiments, the anode may comprise a pure SiC (without any metal) configured to emit the silicon Ka line, and some continuous radiation. This line has an advantage of not efficiently exciting fluorescence from the thick silicon substrate of sample, thus facilitating the measurement of emission from thin films deposited on a surface 13 of sample 30. For example, when a thin aluminum (or any other) layer (e.g., having a thickness less than about 50 nm) is deposited on the silicon substrate of sample 30, using the silicon Ka line does not excite fluorescence radiation from the silicon substrate, but excites fluorescence radiation from the thin aluminum layer, thereby, having the fluorescence radiation from the thin aluminum layer with low background radiation from the silicon substrate. Thus, allowing XRF analysis of the thin aluminum layer more effectively compared to that using anode materials other than SiC. For example, about 25% attenuation is obtained in the Rh Lα emission of the XRF emitted from sample 30 at a depth less than about 100 nm or less than about 1000 nm depending on the sample material. In alternative embodiments, system 11 can be used to measure light elements down to the fluorine K-line, enabling measurement of thin films of aluminum (K line) and germanium (L line).

In some embodiments, system 11 comprises X-ray optics 14 disposed between source 12 and sample 30 and configured to shape beam 23 so as to form a shaped spot 32, e.g., at a predefined measurement site on surface 13 of sample 30. In some embodiments, X-ray optics 14 may be selected to further optimize the setup for certain applications. For polychromatic excitation, for example, a mono- or poly-capillary optic may be used to provide a high incident flux directed to sample 30 with a wide range of energies (e.g., approximately several keVs). In some applications in which a low background is more advantageous than a high flux, a crystal or multilayer monochromator (not shown) may be used to reduce the range of energies to energies around a characteristic emission line from the tube, e.g., Cu Ka.

In some embodiments, system 11 comprises one or more X-ray detectors 16 configured to receive fluorescence radiation, referred to herein as beams 25, which are excited from sample 30 in response to the interaction between sample 30 and X-ray beam 23 impinged thereon.

In some embodiments, system 11 may comprise about four or more detectors 16 that may be arranged in an annular array around optics 14 to increase the detection efficiency of the X-rays of beams 25. In some embodiments, at least one (and typically each) detector 16 may comprise a semiconductor device such as a silicon drift detector (SDD) connected to an energy-dispersive detector, which measures the intensity across wide range a of energies simultaneously, and outputting signals to processor 22.

Additionally, or alternatively, at least one detector 16 may be configured in a wavelength-dispersive setup, with a moving crystal element to select one or more discrete energies and a proportional counter to determine the intensity of the selected line. Wavelength-dispersive setups typically have higher energy resolution compared to that of energy-dispersive setups, which can be advantageous for low-energy analysis.

In some embodiments, X-ray source 12, X-ray optics 14 and detectors 16 reside in an X-ray enclosure, in the present example a vacuum chamber 15 also referred to herein as a chamber 15, for brevity. Moreover, a combination of X-ray source 12, X-ray optics 14 and detectors 16 is referred to herein as an X-ray analysis assembly 10 in the context of the present disclosure. In other embodiments, the components of X-ray analysis assembly 10 are positioned in an environment with low X-ray absorption (other than vacuum), such as in a tank filled with helium. In this configuration vacuum chamber 15 is replaced with a chamber configured to contain the helium gas. In some embodiments, a mix of the aforementioned energy-dispersive and wavelength-dispersive detectors can be present in vacuum chamber 15.

In some embodiments, system 11 comprises a computer 20, which comprises a processor 22, an interface 24 and a display (not shown). Processor 22 is configured to control various components and assemblies of system 11 described below, and to process electrical signals received from detectors 16. Interface 24 is configured to exchange electrical signals between processor 22 and the respective components and assemblies of system 11.

In some embodiments, processor 22 comprises a general-purpose computer, which is programmed in software to carry out the functions described herein. The software may be downloaded to the computer in electronic form, over a network, for example, it may, alternatively or additionally, be provided and/or stored on non-transitory tangible media, such as magnetic, optical, or electronic memory. Additionally, or alternatively, computer 20 comprises any suitable type of a central processing unit (CPU), or a graphical processing unit (GPU), or a tensor processing unit (TPU), a digital signal processor (DSP) or any other suitable type of an application-specific integrated circuit (ASIC). All the above processing units are configured, inter alia, to accelerate deep learning workloads in a neural network that may be used for analyzing signals received from detectors 16.

In some embodiments, system 11 comprises a mount, for example, a motorized stage 40 configured to move in one or more of XYZ directions and to rotate and tilt in rotation and tilting axes (not shown). System 11 further comprises a chuck 21 mounted on stage 40 and configured to hold sample 30. The movement of stage 40 is controlled by processor 22 in the XYZ coordinate system of system 11, as will be described below, and stage 40 and chuck 21 are designed to allow incident beam 23 to directly impinge on surface 13 of sample 30.

In some embodiments, stage 40, chuck 21 and sample 30 (and optionally additional movable components) are placed in atmospheric environment. As described above, the static components of X-ray analysis assembly 10 are placed in vacuum (within vacuum chamber 15) or in another environment with low X-ray absorption, e.g., helium gas, or removing the argon gas (which typically exists in the atmosphere at about 1%) with approximately pure nitrogen gas to remove parasitic peak signal from argon.

In some embodiments, system 11 comprises a stiff window assembly 33, which is transparent to X-rays (having high energy or low energy as will be described below) and is configured to is configured to seal an opening (described below) in chamber 15 to maintain the vacuum (or helium gas pressure) in chamber 15. In other words, window assembly 33 is configured to seal chamber 15 to maintain the pressure (of vacuum or helium gas) and prevent leakage of gas into or out of chamber 15. Moreover, window assembly 33 is configured to allow passage of (i) X-ray beam 23 out of chamber 15, and (ii) the low energy of fluorescence beams 25 into chamber 15. As described above, beams 25 are excited from sample 30 in response to the interaction between sample 30 and X-ray beam 23. The spectral intensity of the X-ray fluorescence is indicative of the elemental composition of one or more layers in sample 30 at shaped spot 32. It is noted that beams 25 propagate in atmospheric environment that absorbs some of the energy, and thereby, reducing the energy of beams 25. System 11 is configured to operate with low-energy beams 25, typical range of the low-energy can be between about 0.6 keV and 3 keV.

In some embodiments, system 11 comprises cables 52 configured to connect between processor 22 (via interface 20) and (i) PSU 26 and/or X-ray source 12 to control the size, shape, intensity and direction of beams 23, (ii) detectors 16 to receive signals indicative of beams 25 emitted from sample 30 and detected by detectors 16, (iii) distance sensor 18 to measure distance between window assembly 33 and sample 30 (as will be described in detail below), and (iv) stage 40 to control the movement and position of sample 30 relative to X-ray analysis assembly 10 via closed loop control.

In some embodiments, additional sensors, such as but not limited to pressure sensor(s), temperature sensor(s) and humidity sensor(s) may be incorporated to system 11 to monitor the environmental conditions in the gap (having a distance 66 described below) between a surface 29 of a window layer 55 (described in detail below) and surface 13 of sample 30. In some embodiments, the readings from these sensors may be included in the measured data analysis to account for changes in the environment surrounding sample 30 over time.

Reference is now made to an inset 19 showing window assembly 33 and a portion of sample 30 having surface 13. In some embodiments, window assembly 33 comprises window layer 55 typically made from a material, such as but not limited to (i) a compound of silicon-nitride (e.g., Si₃N₄ or any other suitable compound), or (ii) graphene, which is a material typically extracted from graphite, and is made up of pure carbon or Sic. The stiffness of silicon-nitride and graphene is determined using the Young's modulus (E), which is calculated using equation (i).

E=σ/E (i)
where σ denotes the tensile stress applied to window layer 55,
and ε denotes the tensile strain caused to window layer 55 in response to the applied tensile stress.

In the present example, the Young's modulus of Si₃N₄ at about 20° C. is between about 100 GPa and 325 GPa, the Young's modulus of SiC at about 20° C. is between about 400 GPa and 700 GPa, and the Young's modulus of graphene at about 20° C. is between about 1 TPa and 2.5 TPa. In some embodiments, window layer 55 is made from Si₃N₄ supplied by Norcada Inc. 4548-99 Edmonton, AB T6E 5H5 Canada and has a thickness 77 less than about 1 μm (e.g., between about 0.4 μm and 0.7 μm).

In alternative embodiments, window layer 55 is made from graphene. The example materials Si₃N₄, graphene and SiC of window layer 55 are transparent to beams 23 and 25 and are electrically conductive as will be described below. In other embodiments, window layer 55 may comprise any other suitable stiff material (e.g., beryllium) transparent to low-energy and high-energy X-rays. The Young's modulus of beryllium at about 20° C. is approximately 300 GPa.

In such embodiments, all the materials selected for window layer 55, e.g., Si₃N₄, SiC, beryllium, and graphene, are (i) transparent to X-ray radiation, (ii) stable under X-ray exposure, and (iii) have high stiffness with Young's modulus greater than 100 GPa. It is important to note that high stiffness is important to prevent significant bowing on window layer 55 when operated under vacuum conditions, which is crucial for minimizing the air gap and thereby to reduce the travel of X-rays not under vacuum and improve the performance of the X-ray analysis system.

In some embodiments, window assembly 33 further comprises a layer 44 made from silicon or from any other material. Layer 44 has a thickness 34 (e.g., between about 0.3 mm and 1 mm) and is coupled to the layer of window layer 55. In some embodiments, window assembly 33 is fabricated by depositing, on layer 44, a layer of silicon-nitride or graphene or SiC. Subsequently, an opening 36 is etched in layer 44, in the present example, opening 36 has a length between about 2 mm and 5 mm (typically less than about 3 mm) along the X-axis (and typically also along the Y-axis. It is noted that chamber 15 has an opening with the same size as opening 36. As This fabrication process is provided by way of example, and in other embodiments, any other suitable process may be used for fabrication window assembly 33. In some embodiments, window assembly 33 has a round shape so that opening 36 is an inner diameter of window assembly 33, and an outer diameter 67 of window assembly 33 is between about 4 mm and 6 mm (typically about 5 mm).

In some embodiments, stage 30 is configured to place an outer surface 13 of sample 30 at distance 66 (also referred to herein as an air gap) from an outer surface 29 of window layer 55. In the present example, distance 66 has a length along the Z-axis between about 100 μm and 500 μm, or any other suitable distance less than about 1 mm. It is noted that in this configuration, (i) a first portion of the path of beams 23 and 25 and the detection of beams 25 is carried out in the controlled vacuum environment, and (ii) a second portion (substantially smaller than the first portion) of beams 23 and 25 and the excitation of beams 25 from surface 13, occur in the small (about 100 μm and 500 μm) air gap between surfaces 13 and 29 of sample 30 and windows 55, respectively.

In some embodiments, the high stiffness of the silicon-nitride, graphene and SiC (determined k the Young's modulus described above) combined with the small size (e.g., less than about 3 mm) of opening 36 enables surface 29 of window layer 55 to be substantially parallel to surface 13 of sample 30 in XY plain of the XYZ coordinate system. Moreover, improved flatness of surface 29 in the XY plain may be obtained by increasing the thickness 77 of window layer 55 by several nanometers or tens of nanometers.

In some embodiments, system 11 further comprises a distance sensor 18 coupled to chamber 15 and configured to measure distance 66 between surfaces 13 and 29. In an embodiment, distance sensor 18 comprises a laser triangulation gauge or a confocal white light sensor, with reading time frequency less than about 1 second per measurement site and a resolution and precision of the displacement less than about 1 μm.

In some embodiments, processor 22 is configured to control the movement of stage 40 in XY plane approximately (approximately parallel to surface 13 of sample 30) and to maintain the aforementioned 100 μm-500 μm air gap (distance 66) while performing the XRF measurements and analysis. In some embodiments, distance sensor 18, also referred to herein as a proximity sensor, is configured to output a signal indicative of the air gap distance 66, so as to reduce the X-ray attenuation in beams 23 and 25, and the variability of the energy of beams 23 and 25 that may occur due to small fluctuations in the ambient conditions surrounding sample 30. In some embodiments, processor 22 is configured to control supplying a continuous flow of gas, such as helium or nitrogen (to remove parasitic peak signal from argon as described above), causing less attenuation of the energy of beams 25 compared to the attenuation of the energy of beams 25 in the presence of air or other gases in the air gap (distance 66).

In some embodiments, window assembly 33 is made from electrically conductive materials, such as the graphene layer(s) of window layer 55 having electrical conductivity in the order of about 10⁶ siemens/meter (S/m), and the silicon of layer 44 and SiC whose electrical conductivity is determined by the type and concentration of dopant embedded in the matrix of silicon and SiC. For example, using high concentration of boron dopants may obtain sufficiently high electrical conductivity of the silicon layer, e.g., about 8.3×10⁴ S/m. In some embodiments, this configuration reduces (and preferably prevents) electrons (and charged particles) emitted from surface 13 of sample 30 from being undesirably adhered to outer surface 29 of window layer 55 and/or from entering detector(s) 16, thereby interfering with the accuracy of the detection of beams 25. Additionally, or alternatively, system 11 comprises a magnetic-based charge trap (MT) 88 integrated within vacuum chamber 15, for example, between (i) a surface 31 of window layer 55 and (ii) detectors 16. In the present implementation, MT 88 comprises an electrically conductive coil (e.g., made from copper) arranged in a plain parallel with a surface 39 of one or more of detectors 16, so as to trap any electrons and/or changed particle directed toward detectors 16.

In some embodiments, after concluding XRF the measurements, processor 22 is configured to control stage 40 to unload sample 30, and to upload the next sample 30 intended to undergo XRF measurements by system 11. The arrangement of sample 30 in atmospheric environment (i.e., out of vacuum chamber 15) eliminates the need to load, lock, and evacuate the vacuum chamber 15 for each new sample 30.

In some embodiments, the configuration of system 11 can be used as part of a multi-channel system, for example including two or more micro-XRF (UXRF) channels with different X-ray sources, optics, and/or operating conditions (e.g., voltages, currents, spot-size), so as to optimize the measurement of different materials in sample 30. In such embodiments, system 11 may be used as an XRF measurement channel combined with a system implementing other measurement techniques, such as but not limited to X-ray methods such as high resolution X-ray diffraction (HR XRD), X-ray reflection (XRR), X-ray photoelectron spectroscopy (XPS), and small-angle X-ray spectroscopy (SAXS), as well as optical measurement techniques such as reflectometry, optical scatterometry, and Raman spectroscopy.

In some embodiments, based on the disclosed techniques and the configuration of system 11, most of the path of the XRF emitted from sample 30 travels though vacuum, thereby allowing analysis of low-Z elements (e.g., elements having atomic weight less than about 20) such as aluminum, phosphorus sodium, magnesium, sulfur, chlorine using their K-shell X-ray emission lines. Moreover, the disclosed techniques and the configuration of system 11 allow XRF analysis of some materials having atomic weight greater than about 30 (e.g., germanium (Ge), silver (Ag), tin (Sn)) by analyzing their lower energy emission lines such as L-shell X-ray. In such embodiments, the thicknesses of the layers of materials described above are typically between about 5 angstrom and 1 μm.

This particular configuration of system 11 is shown by way of example, in order to illustrate certain problems that are addressed by embodiments of the present invention and to demonstrate the application of these embodiments in enhancing the performance of such an XRF analysis system. Embodiments of the present invention, however, are by no means limited to this specific sort of example system, and the principles described herein may similarly be applied to other sorts of X-ray analysis systems known in the art.

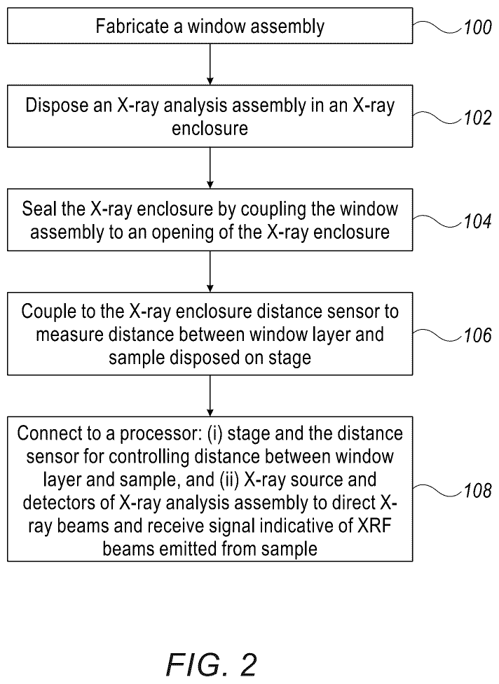

FIG. 2 is a flow chart that schematically illustrates a method for producing system 11, in accordance with an embodiment of the present invention.

The method begins at a window assembly fabrication step 100 with fabricating window assembly 33 having opening 36 and window layer 55 that has a thickness between about 0.4 μm and 0.7 μm, as described in detail in FIG. 1 above.

At an X-ray analysis assembly disposing step 102, X-ray analysis assembly 10 (comprising X-ray source 12, X-ray optics 14 and detectors 16) is disposed in an X-ray enclosure, also referred to herein as chamber 15, as described in detail in FIG. 1 above.

At a sealing step 104, chamber 15 is sealed by coupling window assembly 33 to an opening in chamber 15, which has the same size as the aforementioned opening 36, as described in detail in FIG. 1 above.

At a sensor coupling step 106, distance sensor 18 is coupled to chamber 15, In some embodiments, distance sensor 18 is configured to measure distance 66 between surface 13 of sample 30 and surface 29 of window layer 55, as described in detail in FIG. 1 above.

At a connecting step 108 that concludes the method, processor 22 is connected to: (i) stage 40 and distance sensor 18 for controlling distance 66 between surface 13 of sample 30 and surface 29 of window layer 55, and (ii) X-ray source 12 and detectors 16 of X-ray analysis assembly 10, to direct X-ray beams 23 toward sample 30, and to receive from detector(s) 16 signal(s) indicative of XRF beams 25 emitted from sample 30 in response to beams 23 impinging on surface 13, as described in detail in FIG. 1 above.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system for X-ray analysis, the system comprising:
an X-ray analysis assembly, which is (i) disposed in an X-ray enclosure configured to maintain a controlled first pressure, and (ii) configured to direct a first X-ray beam toward a sample positioned out of the X-ray enclosure at a second pressure different from the first pressure, and to produce a signal indicative of a second X-ray beam emitted from the sample in response to the first X-ray beam impinging on the sample; and
a window assembly, which is disposed between the X-ray analysis assembly and the sample and is configured to (i) seal the X-ray enclosure to maintain a pressure difference between the first and second pressures, and (ii) pass the first and second X-ray beams, wherein the window assembly comprises a window layer made from a material transparent to the first and second X-ray beams.

2. The system according to claim 1, wherein the window layer comprises a compound of silicon-nitride.

3. The system according to claim 1, wherein the window layer comprises a membrane of graphene or silicon carbide (SiC).

4. The system according to claim 1, wherein the X-ray analysis assembly comprises or more detectors configured to produce the signal in response to detecting the second X-ray beam, and wherein the window layer is electrically conductive and is configured to prevent electrons and charged particles emitted from the sample from at least one of (i) adhering to a window surface of the window layer facing the sample, and (ii) entering the one or more detectors.

5. The system according to claim 1, wherein the X-ray analysis assembly comprises one or more detectors configured to produce the signal in response to detecting the second X-ray beam, and comprising a charge trap integrated within the X-ray enclosure and configured to prevent electrons and charged particles from entering the one or more detectors.

6. The system according to claim 1, wherein the sample is disposed on a stage configured to move the sample along at least an axis, and comprising a processor configured to control the stage to move the sample along the axis relative to the X-ray enclosure and to position a first surface of the sample at a distance less than 0.5 mm from the window surface of the window layer facing the first surface.

7. The system according to claim 6, wherein the second pressure comprises an atmospheric pressure, and wherein the processor is configured to control a flow of a helium gas or a nitrogen gas between the first and second surfaces.

8. The system according to claim 1, wherein the window assembly comprises the window layer made from the material, which is formed over an additional layer, wherein the additional layer (i) is less transparent to the first and second X-ray beams compared to the window layer, and (ii) has an opening for passing the first and second X-ray beams.

9. The system according to claim 8, wherein the opening is smaller than 5 mm, and wherein the window layer has a thickness less than 0.5 μm.

10. The system according to claim 1, wherein the X-ray analysis assembly has an X-ray source comprising: (i) an anode having an anode metal film configured to emit the first X-ray beam having a given energy, the anode metal film (a) has an electrical conductivity greater than 8.3×10⁴ S/m and (b) is formed over a base layer having a thermal conductivity greater than 300 W/(m-K) at 600° C., and (ii) one or more cathode emitters configured to produce an electron beam directed to the anode to produce the first X-ray beam, wherein the second pressure comprises an atmospheric pressure, and wherein the second X-ray beam comprises X-ray fluorescence (XRF) emitted from the sample at a depth less than 1000 nm.

11. A method for producing an X-ray analysis system, the method comprising:
disposing, in an X-ray enclosure configured to maintain a controlled first pressure, an X-ray analysis assembly configured to direct a first X-ray beam toward a sample positioned out of the X-ray enclosure at a second pressure different from the first pressure, and to produce a signal indicative of a second X-ray beam emitted from the sample in response to the first X-ray beam impinging on the sample; and
coupling, to the X-ray enclosure, a window assembly configured to (i) seal the X-ray enclosure to maintain a pressure difference between the first and second pressures, and (ii) pass the first and second X-ray beams, wherein the window assembly comprises a window layer made from a material transparent to the first and second X-ray beams.

12. The method according to claim 11, wherein coupling the window assembly comprises coupling the window layer made from a compound of silicon-nitride.

13. The method according to claim 11, wherein coupling the window assembly comprises coupling the window layer made from a membrane of graphene or silicon carbide (Sic).

14. The method according to claim 11, wherein disposing the X-ray analysis assembly comprises disposing one or more detectors configured to produce the signal in response to detecting the second X-ray beam, and wherein coupling the window assembly comprises coupling the window layer which is electrically conductive and is configured to prevent electrons and charged particles emitted from the sample from at least one of (i) adhering to a window surface of the window layer facing the sample, and (ii) entering the one or more detectors.

15. The method according to claim 11, wherein disposing the X-ray analysis assembly comprises disposing one or more detectors configured to produce the signal in response to detecting the second X-ray beam, and integrating within the X-ray enclosure a charge trap configured to prevent electrons and charged particles from entering the one or more detectors.

16. The method according to claim 11, further comprising disposing the sample on a stage configured to move the sample along at least an axis, and connecting the stage to a processor configured to control the stage to move the sample along the axis relative to the X-ray enclosure and to position a first surface of the sample at a distance less than 0.5 mm from the window surface of the window layer facing the first surface.

17. The method according to claim 16, wherein the second pressure comprises an atmospheric pressure, and comprising connecting the processor to a helium gas or a nitrogen gas for controlling a flow of the helium gas or the nitrogen gas, respectively, between the first and second surfaces.

18. The method according to claim 11, further comprising forming the window assembly by forming the window layer over an additional layer, which is less transparent to the first and second X-ray beams compared to the window layer, and forming, in the additional layer, an opening for passing the first and second X-ray beams.

19. The method according to claim 18, wherein forming the opening comprises forming the opening that is smaller than 5 mm, and wherein forming the window layer comprises depositing the window layer having a thickness less than 0.5 μm.

20. The method according to claim 11, wherein disposing the X-ray analysis assembly comprises disposing an X-ray source comprising: (i) an anode having an anode metal film configured to emit the first X-ray beam having a given energy, the anode metal film (a) has an electrical conductivity greater than 8.3×10⁴ S/m and (b) is formed over a base layer having a thermal conductivity greater than 300 W/(m-K) at 600° C., and (ii) one or more cathode emitters configured to produce an electron beam directed to the anode to produce the first X-ray beam, wherein the second pressure comprises an atmospheric pressure, and wherein the second X-ray beam comprises X-ray fluorescence (XRF) emitted from the sample at a depth less than 1000 nm.
